(19) United States
(12) Patent Application Publication
(10) Pub. No.: US 2019/0084896 A1
(43) Pub. Date: Mar. 21, 2019

(54) Aerobic Composting System

(71) Applicant: Daniel T. Scott, Houston, TX (US)

(72) Inventor: Daniel T. Scott, Houston, TX (US)

(21) Appl. No.: 15/705,362

(22) Filed: Sep. 15, 2017

(51) Int. Cl. C05F 17/02; B01F 3/04; C05F 17/00; C05F 9/02

(52) U.S. Cl. CPC C05F 17/027; B01F 3/0412; B01F 3/04539; C05F 17/0018; C05F 17/0276; C05F 9/02; B01F 2215/0054; B01F 2003/04163; B01F 2003/04191; B01F 2003/04361; B01F 2003/04709; B01F 2003/04879; C05F 17/0258

(57) ABSTRACT

An aerobic composting system and method utilizes circulation of a gas through a mixture of liquid and organic materials to continuously mix the liquid and organic materials while encouraging aerobic organisms which aid with the composting process. The aerobic composting system generally includes a container which is adapted to store a volume of a liquid to be continuously mixed with organic materials to produce compost. The container may include a first opening through which the liquid and/or organic materials are introduced into a cavity of the container. The container may also include a second opening such as a spigot through which the resulting compost is dispensed. A gas dispenser is positioned on the floor of the container within the cavity to continuously dispense a gas through the liquid so as to mix the organic materials with the liquid and to encourage aerobic organisms which aid with the composting process.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to an aerobic composting system which utilizes bubbling of a gas through a mixture of liquid and organic materials to continuously agitate and mix the liquid and organic materials while supporting aerobic organisms which aid with the composting process.

### Related Art

Any discussion of the related art throughout the specification should in no way be considered as an admission that such related art is widely known or forms part of common general knowledge in the field.

Composting processes have been used for many years to produce compost. Organic waste materials can be decomposed aerobically to create nutrient-rich compost. Various methods and systems have been previously used for production of composts by decomposition of organic materials.

Compost piles can be an effective method of producing compost, but suffer from several disadvantages. Compost piles require constant and close monitoring to adjust moisture and oxygen levels. Such adjustments may include turning and mixing the compost pile or adding dry organic material which can be labor-intensive and time-consuming. If the oxygen level is not sufficient for aerobic decomposition, anaerobic organisms may dominate leading to the emission of unpleasant odors. If the moisture level is not sufficient, the composting process will slow down or stop all together. Compost piles may also attract animals such as pests (insects, rodents, etc.).

Compost bins and compost tumblers have also previously been used to produce compost. Compost bins are incapable of turning and mixing the compost and suffer from difficulty delivering oxygen within the bin and difficulty monitoring and controlling moisture levels.

Compost tumblers address such disadvantages of a compost bin by adding the ability to turn and mix the compost such as by rotating the vessel containing the organic waste material. However, compost tumblers still require close monitoring of the moisture levels and periodic turning of the device to mix the contents.

Another method of composting used previously is the brewing of a compost tea. Compost tea is brewed in a tank of water with air bubbling through a permeable container of mature compost. The compost tea brewer creates conditions for the aerobic organisms living within the compost to proliferate in the water. The water is then used to inoculate plants and soil, such as through a sprayer.

### SUMMARY

An example embodiment is directed to an aerobic composting system. The aerobic composting system includes a container which is adapted to store a volume of a liquid to be continuously agitated and mixed with organic materials to produce compost. The container may include a first opening through which the liquid and/or organic materials are introduced into a cavity of the container. The container may also include a second opening such as a spigot through which the resulting compost is dispensed. A gas dispenser such as an aerator is positioned on the floor of the container within the cavity to continuously dispense a gas through the liquid so as to agitate and mix the organic materials with the liquid and to encourage aerobic organisms which aid with the composting process.

There has thus been outlined, rather broadly, some of the embodiments of the aerobic composting system in order that the detailed description thereof may be better understood, and in order that the present contribution to the art may be better appreciated. There are additional embodiments of the aerobic composting system that will be described hereinafter and that will form the subject matter of the claims appended hereto. In this respect, before explaining at least one embodiment of the aerobic composting system in detail, it is to be understood that the aerobic composting system is not limited in its application to the details of construction or to the arrangements of the components set forth in the following description or illustrated in the drawings. The aerobic composting system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of an aerobic composting system in accordance with an example embodiment.

FIG. 2 is a side view of an aerobic composting system in accordance with an example embodiment.

FIG. 3 is a frontal view of an aerobic composting system in accordance with an example embodiment.

FIG. 4 is a cutaway perspective view of an aerobic composting system in accordance with an example embodiment.

FIG. 5 is a side view of an aerobic composting system in an empty state in accordance with an example embodiment.

FIG. 6 is a side view of an aerobic composting system filled with a liquid in accordance with an example embodiment.

FIG. 7 is a side view of an aerobic composting system with aerated liquid in accordance with an example embodiment.

FIG. 8 is a side view of an aerobic composting system being filled with organic materials in accordance with an example embodiment.

FIG. 9 is a side view of an aerobic composting system in which the liquid and organic materials are being mixed in accordance with an example embodiment.

FIG. 10 is a side view of an aerobic composting system dispensing compost in accordance with an example embodiment.

FIG. 11 is a cutaway perspective view of an aerobic composting system utilizing a rotating dispenser arm in accordance with an example embodiment.

FIG. 12 is a sectional view of an aerobic composting system utilizing a rotating dispenser arm aerating a liquid in accordance with an example embodiment.

FIG. 13 is a sectional view of a gas dispenser of an aerobic composting system in accordance with an example embodiment.

FIG. 14 is a flowchart illustrating filling of the container with organic materials and activating the pump in accordance with an example embodiment.

FIG. 15 is a flowchart illustrating the composting process in accordance with an example embodiment.

FIG. 16 is a flowchart illustrating compost being dispensed in accordance with an example embodiment.

### DETAILED DESCRIPTION

### A. Overview.

An example aerobic composting system 10 generally comprises a container 20 which is adapted to store a volume of a liquid 40 to be continuously mixed with organic materials 42 to produce compost 46. The container 20 may include a first opening 26 through which the liquid 40 and/or organic materials 42 are introduced into a cavity 25 of the container 20. The container 20 may also include a second opening 27 such as a spigot 29 through which the resulting compost 46 is dispensed. A gas dispenser 34 such as an aerator is positioned on the floor 33 of the container 20 within the cavity 25 to continuously dispense a gas 44 through the liquid 40 so as to mix the organic materials 42 with the liquid 40 and to encourage aerobic organisms which aid with the composting process.

A broad exemplary embodiment of the aerobic composting system 10 may comprise a container 20 adapted to store a volume of a liquid 40. The container 20 may comprise an upper end 21, a lower end 22, and a cavity 25 for storing the volume of the liquid 40. The container 20 may comprise a floor 33 within the cavity 25.

An inlet, such as a first opening 26 on the container 20, is adapted to receive an organic material 42 such that the organic material 42 is mixed with the liquid 40. The first opening 26 may be positioned on the upper end 21 of the container 20. An outlet, such as a second opening 27 on the container 20 is adapted to dispense a compost 46 produced by decomposition of the organic material 42 within the liquid 40. The second opening 27 may include a spigot 29 for selectively dispensing the compost 46. A cover 28 may be provided for selectively covering the first opening 26. The cover 28 may be hingedly connected to the container 20.

A gas dispenser 34 is positioned within the container 20; with a pump 30 supplying gas 44 to the gas dispenser 34. The pump 30 may be positioned near or at the upper end 21 of the container 20. A transfer conduit 32 may be connected between the pump 30 and the gas dispenser 34 to transfer the gas 44 from the pump 30 to the gas dispenser 34. The transfer conduit 32 may extend along the inner wall 24 of the container 20 between the upper end 21 and the lower end 22 of the container 20.

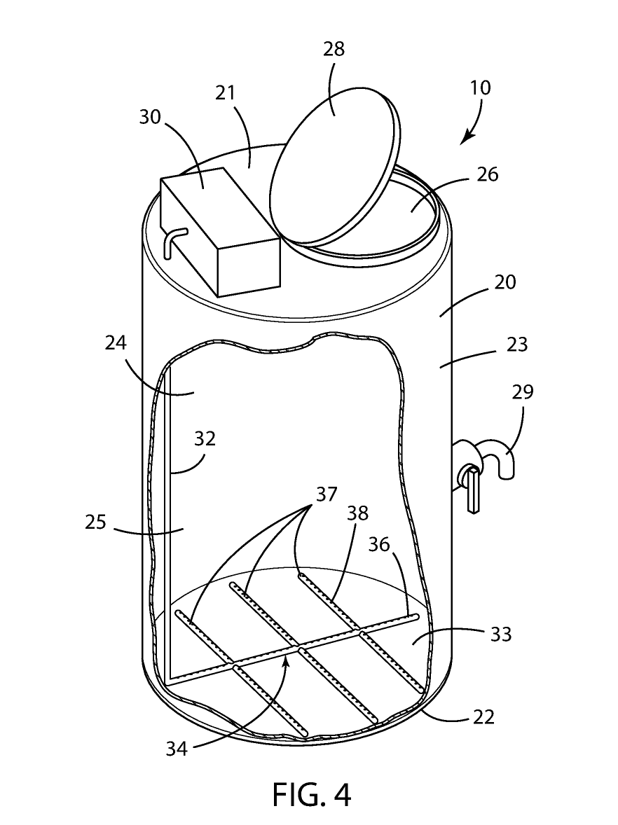

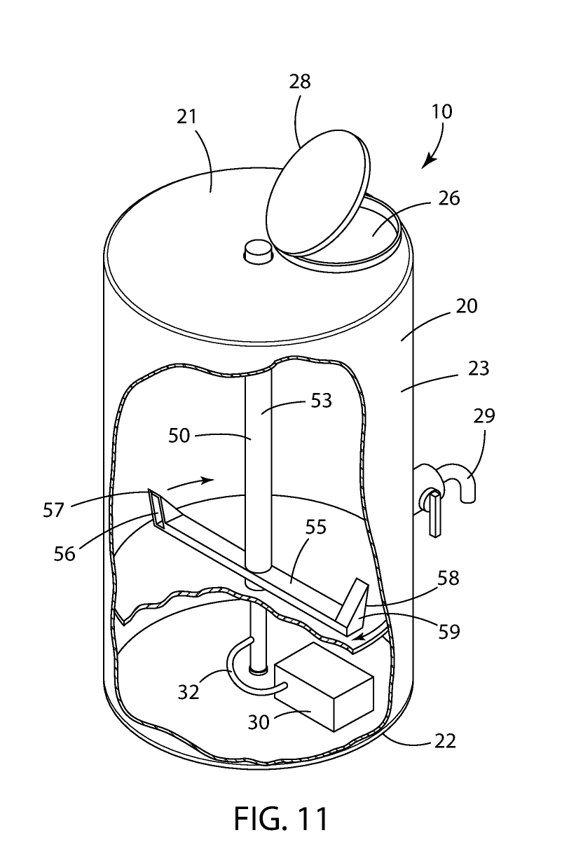

The gas dispenser 34 is adapted to direct the gas 44 through the liquid 40 so as to continuously agitate the liquid 40 and the organic material 42 to produce the compost 46. Various types of gas dispensers 34 may be utilized. FIGS. 4-10 illustrate a first embodiment of a gas dispenser 34 and FIGS. 11-13 illustrate a second embodiment of a gas dispenser 34.

In the embodiment of FIGS. 4-10, the gas dispenser 34 is comprised of a plurality of dispenser arms 37 each having a plurality of apertures 38 through which the gas 44 is dispensed into the liquid 40. The gas dispenser 34 may comprise a central dispenser conduit 36; with the dispenser arms 37 extending outwardly from the central dispenser conduit 36 to form a grid substantially covering the floor 33 of the container 20 within the cavity 25. The central dispenser conduit 36 may extend across the floor 33 of the container 20.

In the embodiment of FIGS. 11-13, the gas dispenser 34 is comprised of a flow conduit 50 extending upwardly from the floor 33 within the cavity 25 of the container 20. A pump 30 is fluidly connected to the flow conduit 50 for supplying gas 44 to the flow conduit 50. A dispenser arm 55 is fluidly connected to the flow conduit 50; with the dispenser arm 55 being adapted to dispense the gas 44 through the liquid 40.

The dispenser arm 55 may rotate within the cavity 25 when the pump 30 is activated. The flow conduit 50 may comprise an inner tube 51 and an outer tube 53; with the inner tube 51 connected to the pump 30 and the outer tube 53 connected to the dispenser arm 55. The outer tube 53 and the dispenser arm 55 may rotate about the inner tube 51 when the pump 30 is activated.

A first end of the dispenser arm 55 may include a first dispenser outlet 56 and the second end of the dispenser arm 55 may include a second dispenser outlet 58. The first dispenser outlet 56 may include a first fin 57 oriented in a first direction and the second dispenser outlet 58 may include a second fin 59 oriented in a second direction such that the dispenser arm 55 rotates within the cavity 25 when the pump 30 is activated.

Various types of liquids 40 and gasses 44 may be utilized. One embodiment uses a liquid 40 comprised of water and a gas 44 comprised of oxygen to aerate the liquid 40. The organic material 42 may comprise a liquid, a solid, or a semi-solid. Often a mixture of different types of organic materials 42 will be utilized.

Also disclosed is a method for producing compost 46. The method may include the storing of a volume of a liquid 40 within the container 20; with the container 20 comprising an upper end 21, a lower end 22, a cavity 25 for storing the liquid 40, and a floor 33 within the cavity 25. Organic material 42 is introduced into the liquid 40 through the first opening 21 on the container 20. The first opening 21 may be covered, such as by a cover 28, to prevent unauthorized access to the cavity 25 and to prevent emission of odors and the like.

A gas 44 is dispensed through the liquid 40 within the container 20 with a gas dispenser 34. The gas dispenser 34 may comprise a central dispenser conduit 36 and a plurality of dispenser arms 37 each extending outwardly from the central dispenser conduit 36 to form a grid covering the floor 33 of the container 20 within the cavity 25. The organic material 42 is mixed within the liquid 40 to produce the compost 46 by the bubbling of the gas 44 up through the liquid 40. The gas 44 will also support aerobic organisms to aid in decomposition and discourage anaerobic organisms which produce odors. The resulting liquid, solid, or semi-solid compost 46 may be dispensed through as second opening 27 on the container 20, such as by a spigot 29.

### B. Container.

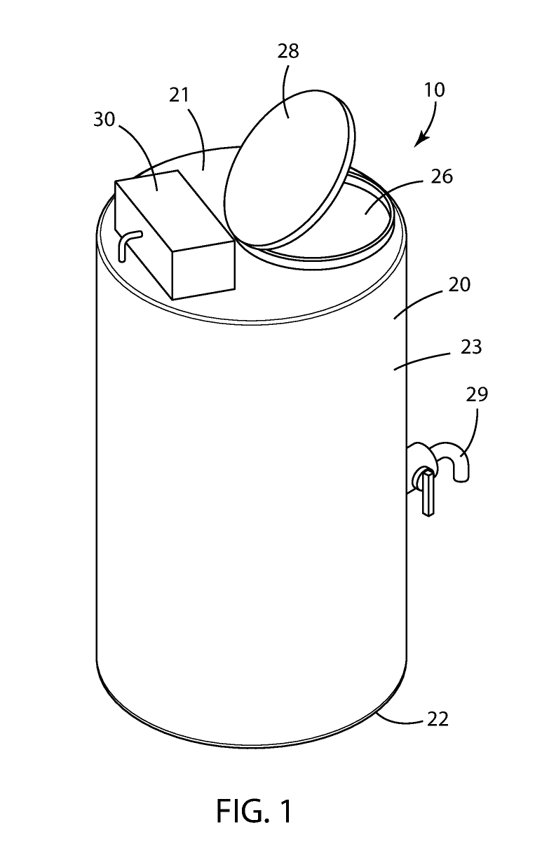

As best shown in FIGS. 1-4, a container 20 is utilized to store aerated liquid 40 which is mixed with organic materials 42 to produce compost 46. The shape, size, and configuration of the container 20 may vary in different embodiments and thus should not be construed as limited by the exemplary embodiments shown in the figures. In the embodiment shown in the figures, the container 20 is illustrated as comprising a cylindrical shape.

As shown in FIG. 1, the container 20 may include an upper end 21 and a lower end 22. The lower end 22 of the container 20 is preferably positioned on a flat surface. The container 20 includes a cavity 25 in which the liquid 40 and organic materials 42 are mixed. The container 20 includes an outer wall 23 external of the container 20 and an inner wall 24 facing toward the cavity 25. The container 20 also includes a floor 33 within the cavity 25.

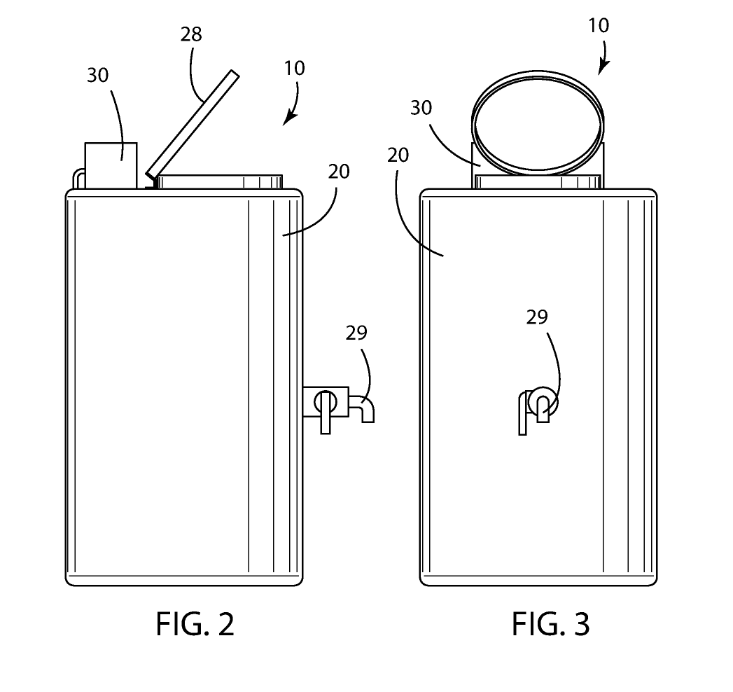

As shown in FIGS. 2-3, the container 20 may include one or more openings 26, 27 which may serve as an inlet or outlet. In some embodiments, the container 20 may include a single opening which serves as both an inlet and an outlet. The number and positioning of the openings 26, 27 may vary and should not be construed as being limited in any manner by the exemplary figures.

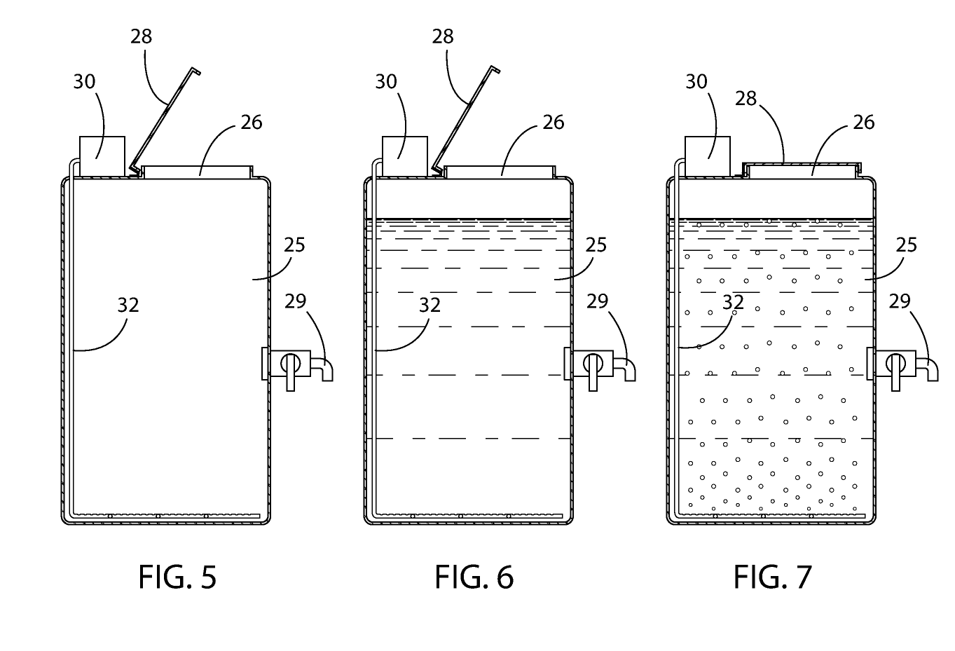

In the exemplary embodiment shown in FIGS. 5-10, the container 20 may include a first opening 26 which serves as an inlet to receive both the liquid 40 and organic materials 42. The first opening 26 may be positioned at the upper end 21 of the container 20 as shown in FIGS. 4. In other embodiments, the first opening 26 may be positioned at various other locations which allow access to the cavity 25 of the container 20, such as on the outer wall 23 of the container 20.

A cover 28 may be utilized which selectively covers the first opening 26 so as to prevent contamination by weather condition such as rain. The cover 28 may also prevent unauthorized access to the cavity 26 of the container 20, such as by wildlife. The cover 28 may be hingedly connected to the container 20 and may be releasably connected to cover the first opening 26 in any manner known in the art. In some embodiments, the cover 28 may be selectively locked.

As shown in FIG. 10, the container 20 may comprise a second opening 27 which serves as an outlet to distribute liquid and/or solid compost 46. In the exemplary embodiment shown in the figures, the second opening 27 is positioned on the lower half of the container 20. The second opening 27 may include a spigot 29 which allows selective distribution of the compost 46.

### C. Gas Dispenser.

As best shown in FIGS. 4 and 7-10, a gas dispenser 34 is utilized to dispense a gas 44 through the liquid 40. The gas dispenser 34 may comprise any device or the like adapted to dispense the gas 44 through the liquid 40, such as an aerator. For example, the liquid 40 may be aerated by circulation of air through the liquid 40. The gas 44 may comprise various gasses, and in some embodiments could comprise a mixture of gases. It should be appreciated that any gas 44 or gasses 44 may be utilized which are useful for composting processes.

Bubbling of the gas 44 through the liquid 40 continuously mixes the liquid 40 and the organic materials 42. It is preferable that the gas 44 is dispensed so as to uniformly and substantially agitate and aerate the volume of the liquid 40. Additionally, the gas 44 may assist with the composting process by encouraging and supporting organisms which aid in the composting process by breaking down and decomposing the organic material 42. The gas 44 may be continuously bubbled through the liquid 40 or may be periodically bubbled through the liquid 40.

The gas dispenser 34 is fed the gas 44 by a pump 30 as shown in FIG. 4. The pump 30 may be external to the container 20 as shown in the figures, or may be internal to the container 20 in some embodiments. The pump 30 is illustrated as being positioned or connected to the upper end 21 of the container 20. However, the pump 30 could in other embodiments be connected to different parts of the container 20, such as on the outer wall 23 or near the lower end 22.

In other embodiments, the pump 30 may be separate from the container 20 and connected by a conduit such as a hose to the gas dispenser 34. As shown in FIG. 4, whether the pump 30 is connected to or separated from the container 20, a transfer conduit 32 may be connected between the pump 30 and the gas dispenser 34 so as to transfer the gas 44 from the pump 30 to the gas dispenser 34.

The shape, size, orientation, and positioning of the transfer conduit 32 may vary in different embodiments. The transfer conduit 32 may be external, internal, or a mix of both with respect to the container 20. In the embodiment shown in the figures, the transfer conduit 32 extends between the upper and lower ends 21, 22 of the container 20 along its inner wall 24.

In such an embodiment, the pump 30 is of sufficient strength to transfer the gas 44 down along the height of the container 20 between its upper and lower ends 21, 22 to feed the gas 44 to the gas dispenser 34. The pump 30 will preferably be of sufficient strength to supply enough pressure to force the gas 44 to the gas dispenser 34 from wherever it is located.

In the embodiment shown in FIG. 4, the gas dispenser 34 is illustrated as comprising a central dispenser conduit 36 and a plurality of dispenser arms 37 each extending outwardly from the central dispenser conduit 36. The shape, structure, and configuration of the gas dispenser 34 may vary in different embodiments and thus should not be construed as limited by the exemplary embodiment shown in the figures.

It is preferable to apply uniform circulation of gas 44 throughout the liquid 40 and organic material 42. The gas dispenser 34 is illustrated as comprising a grid-like pattern formed by the central dispenser conduit 36 and dispenser arms 37 which substantially covers the floor 33 of the container 20 within the cavity 25. This allows the bubbling gas 44 to uniformly cover the volume of the liquid 40 so as to agitate the organic material 42 within the liquid 40. By minimizing portions of the liquid 40 which are still or not aerated, the composting process may be substantially improved.

As shown in FIG. 4, each of the dispenser arms 37 may extend outwardly from the central dispenser conduit 36 to form such a grid. Although each of the dispenser arms 37 is illustrated as being at a right angle with respect to the central dispenser conduit 36, it should be appreciated that other angles could be utilized. For example, each of the dispenser arms 37 could extend diagonally with respect to the central dispenser conduit 36. Dispenser arms 37 could themselves have additional dispenser arms 37 branching off to form the grid.

The central dispenser conduit 36 may comprise an elongated conduit which extends across the floor 33 of the container 20 within the cavity 25 such as shown in FIG. 4. A plurality of apertures 38 are positioned along the length of the central dispenser conduit 36; with the gas 44 being dispensed through the apertures 38. The central dispenser conduit 36 may be directly connected to the pump 30 or may be interconnected with the pump 30 via the transfer conduit 32 such as in the embodiment shown in FIG. 4.

Each of the dispenser arms 37 may comprise an elongated conduit which extends outwardly from the central dispenser conduit 36 such as shown in FIG. 4. The dispenser arms 37 are utilized to provide coverage of the floor 33 of the container 20 within the cavity 25 to ensure uniform bubbling of the gas 44 through the liquid 40 within the container 20. It is preferable that a substantial portion of the floor 33 of the container 20 within the cavity 25 is covered by the dispenser arms 37.

The shape, number, size, and orientation of the dispenser arms 37 may vary in different embodiments and thus should not be construed as limited by the exemplary figures. The size of the container 20 and area of the floor 33 within the cavity 25 will largely determine the optimal configuration of the dispenser arms 37.

Each of the dispenser arms 37 includes a plurality of apertures 38 through which the gas 44 is dispensed to be bubbled through the liquid 40. The apertures 38 may extend along the length of each of the dispenser arms 37 or may cover only portions of each gas dispenser arm 37. The apertures 38 are preferably spaced so as to provide sufficient coverage of the dispenser arms 37 to allow for uniform coverage of the volume of the liquid 40.

FIGS. 11-13 illustrate an alternate embodiment of a gas dispenser 34. The embodiment shown in FIGS. 11-13 comprises a central flow conduit 50 which extends vertically from the lower end 22 to the upper end 21 of the container 20. In the exemplary embodiment shown in the FIGS. 11-13, the flow conduit 50 extends vertically from a central point on the floor 33 of the cavity 25 of the container 20.

The height to which the flow conduit 50 extends within the cavity 25 may vary. In the embodiment shown in the figures, the upper end of the flow conduit 50 is rotatably connected to the upper end 21 of the container 20. Other configurations could be utilized, including different placement or orientation of the flow conduit 50.

As shown in FIG. 11, the pump 30 is illustrated as being positioned in a compartment below the floor 33 of the cavity 25 near the lower end 22 of the container 20. In this manner, the pump 30 may be directly connected to the flow conduit 50, which extends upwardly from the pump 30. It should be appreciated that the pump 30 could be positioned in various other locations, including external to the container 20. In such an embodiment, a transfer conduit 32 could be utilized to transfer gas 44 from the pump 30 to the flow conduit 50.

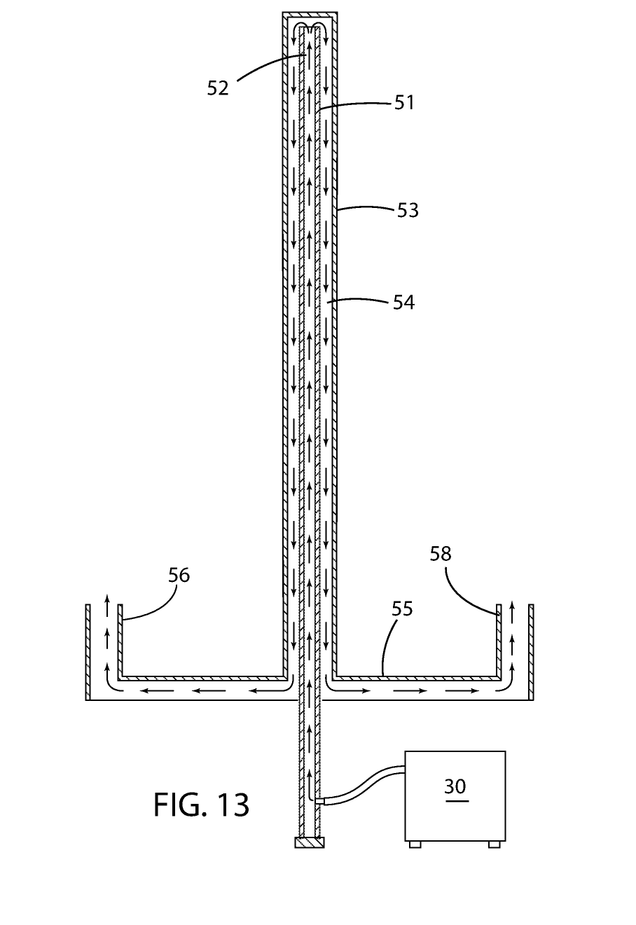

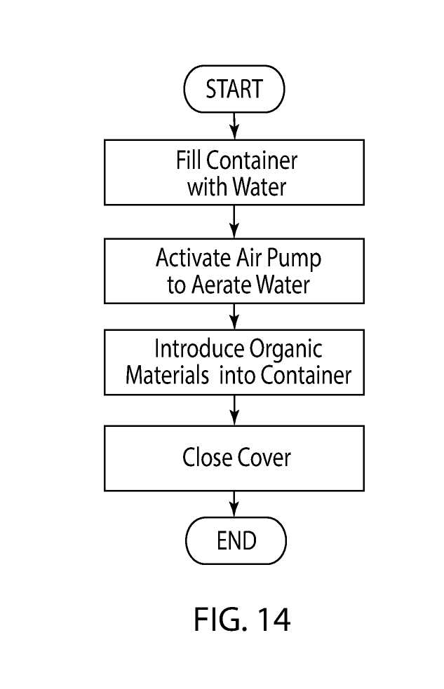

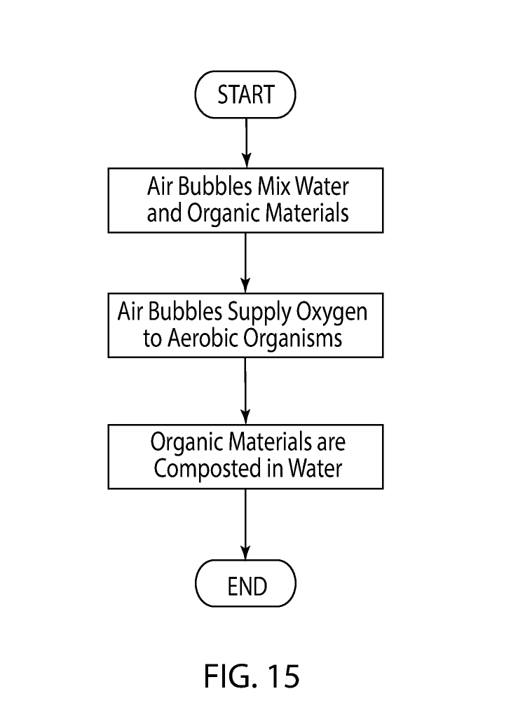

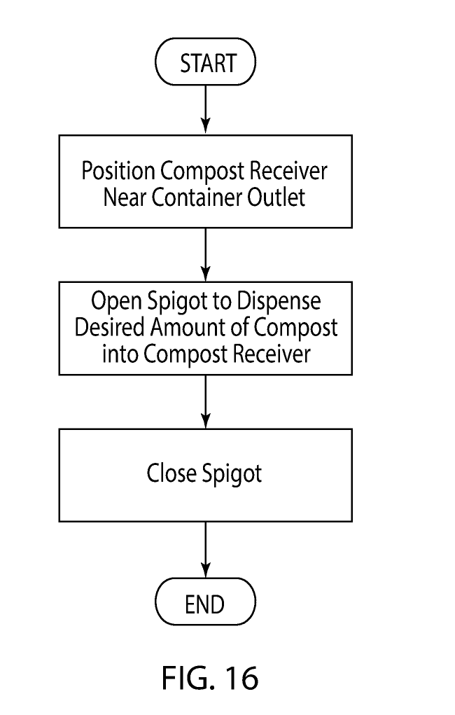

The flow conduit 50 is utilized to direct the flow of the gas 44 from the pump 30 to a dispenser arm 55 as shown in FIG. 13. The flow conduit 50 may comprise an inner tube 51 which is connected to the pump 30 and an outer tube 53 which is rotatably positioned around the inner tube 51. The use of concentric tubes 51, 53 prevents the liquid 40 from reaching the pump 30 when the pump 30 is not running.

The inner tube 51 includes an inner passage 52 through which gas 44 flows upwardly from the pump 30. The space between the exterior of the inner tube 51 and the interior wall of the outer tube 53 defines an outer passage 54 which surrounds the inner tube. Gas 44 will flow from the pump 30 upwardly through the inner passage 52 of the inner tube 51. The gas 44 will then flow downwardly through the outer passage 54 to the dispenser arm 55 as shown in FIG. 13.

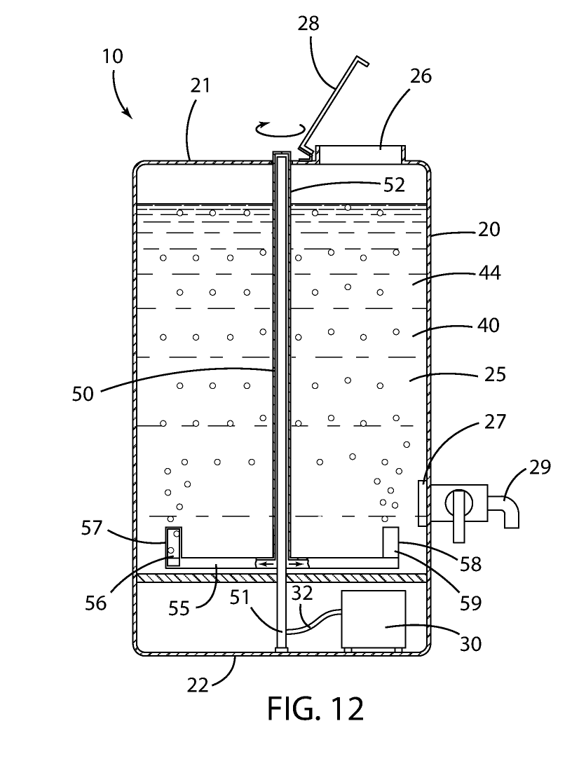

As shown in FIG. 12, the dispenser arm 55 is illustrated as being bisected by the flow conduit 50. The dispenser arm 55 is preferably fixedly connected, such as by welding or the like, to the outer tube 53 of the flow conduit 50 such that the dispenser arm 55 rotates with the outer tube 53 of the flow conduit 50. Although a single dispenser arm 55 is shown in FIGS. 11-13, it should be appreciated that multiple dispenser arms 55 could be utilized, such as in a crossing configuration to form an X-pattern covering the floor 33 of the cavity 25 within the container 20.

The dispenser arm 55 will generally comprise an elongated, hollow member such as shown in FIG. 13. Each end of the dispenser arm 55 includes a dispenser outlet 56, 58; with the first end of the dispenser arm 55 having a first dispenser outlet 56 and the second end of the dispenser arm 55 having a second dispenser outlet 58. As the dispenser arm 55 rotates, a swirling effect will be created similar to a whirlpool effect; with the gas 44 bubbling upwardly in such a swirling motion to uniformly cover the volume of the liquid 40.

Gas 44 from the pump 30 will flow simultaneously through both the first dispenser outlet 56 and the second dispenser outlet 58 when the pump 30 is activated. As shown in FIG. 12, the first dispenser outlet 56 includes a first fin 57 and the second dispenser outlet 58 includes a second fin 59. The fins 57, 59 may be angularly oriented with respect to the dispenser arm 55 such that flow of gas 44 exiting the dispenser outlets 56, 58 will cause the dispenser arm 55 to rotate within the cavity 25. In the embodiment shown in the figures, the first fin 57 is oriented in a first direction and the second fin 59 is oriented in a second direction; with the first direction being opposite of the second direction.

As the dispenser arm 55 is rotated about the flow tube 50 within the cavity 25, gas 44 will be continuously dispensed through the dispenser outlets 56, 58 to bubble upwardly through the liquid 40 stored within the container 20. The rotation of the dispenser arm 55 will also agitate the liquid 40 to further improve mixing of the organic material 42 with the gas 44. Rotation of the dispenser arm 55 will also ensure that uniform gas 44 flow is applied throughout the liquid 40 in the container 20 to properly and efficiently aerate the liquid 40.

### D. Operation of Preferred Embodiment.

In use, the container 20 is first filled with a volume of the liquid 40 as shown in FIGS. 5 and 6. The liquid 40 acts as a composting medium for the organic material 42. The cavity 25 of the container 20 may be partially or fully filled with the liquid 40. The amount of liquid 40 utilized may vary in different embodiments to suit different volumes of organic materials 42. In some embodiments, the container 20 may be filled approximately ¾ of the volume of the cavity 25. For larger volumes of organic materials 42, less liquid 40 will be utilized to account for displacement of the liquid 40 and ensure that the container 20 is not overflowed.

As shown in FIG. 7, the pump 30 may be activated to bubble the gas 44 up through the liquid 40 via the gas dispenser 34. Gas 44 from the pump 30 is transferred to the gas dispenser 34 via the transfer conduit 32 which extends along the inner wall 24 of the container 20 between its upper and lower ends 21, 22. In some embodiments, the transfer conduit 32 may be omitted; with the gas 44 being transferred directly from the pump 30 to the gas dispenser 34.

It should be appreciated that the pump 30 may be activated to dispense the gas 44 either before or after the introduction of organic materials 42 into the cavity 20. In the embodiment shown in the figures, the gas 44 is dispensed through the liquid 40 before the organic materials 42 are introduced. In this manner, the organic materials 42 will be evenly and automatically mixed upon introduction into the liquid 40 within the container 20. Immediate agitation of the organic materials 42 when introduced into the liquid 40 may be beneficial to more efficiently mix the organic materials 42 with the liquid 40.

When the pump 30 is activated, the gas 44 will be transferred to the gas dispenser 34 to be dispensed through the liquid 40. The gas 44 will exit the gas dispenser 34 at or near the floor 33 of the container 20 such that the gas 44 bubbles upwardly from the lower end 22 to the upper end 21 of the container 20 to both aerate the liquid 40 to encourage aerobic organisms and mix the organic materials 42 with the liquid 40 during the composting process. Preferably, the gas 44 is uniformly bubbled across the volume of the liquid 40 so as to uniformly aerate and agitate the mixture of the liquid 40 and the organic materials 42 such as shown in FIG. 9.

In the embodiment of FIGS. 4-10, the grid configuration shown in the figures ensures that the gas 44 is bubbled uniformly throughout the liquid 40 to improve efficiency of the composting process. Gas 44 will exit the gas dispenser 34 through the apertures 38 on the central dispenser conduit 36 and dispenser arms 37 and then bubble up through the liquid 40 within the cavity 25 of the container 20.

In the embodiment of FIGS. 11-13, the rotation of the dispenser arm 55 will both agitate the liquid 40 and uniformly bubble the gas 44 through the liquid 40. Gas 44 will flow up the inner passage 52 of the inner tube 51 of the flow conduit 50. The gas 44 will then flow down the outer passage 54 between the inner tube 51 and the outer tube 53 and be split into two flows; one toward the first dispenser outlet 56 and the other toward the second dispenser outlet 58.

As shown in FIG. 13, the gas 44 will exit through the dispenser outlets 56, 58 on the respective ends of the dispenser arm 55. The force of the gas 44 exiting the dispenser arm 55 will act on the fins 57, 59. This force will cause the dispenser arm 55 and outer tube 53 to rotate about the inner tube 51. Rotation of the dispenser arm 55 will both agitate the liquid 40 and to ensure a uniform application of the gas 44 within the liquid 40 using a whirlwind or swirling effect.

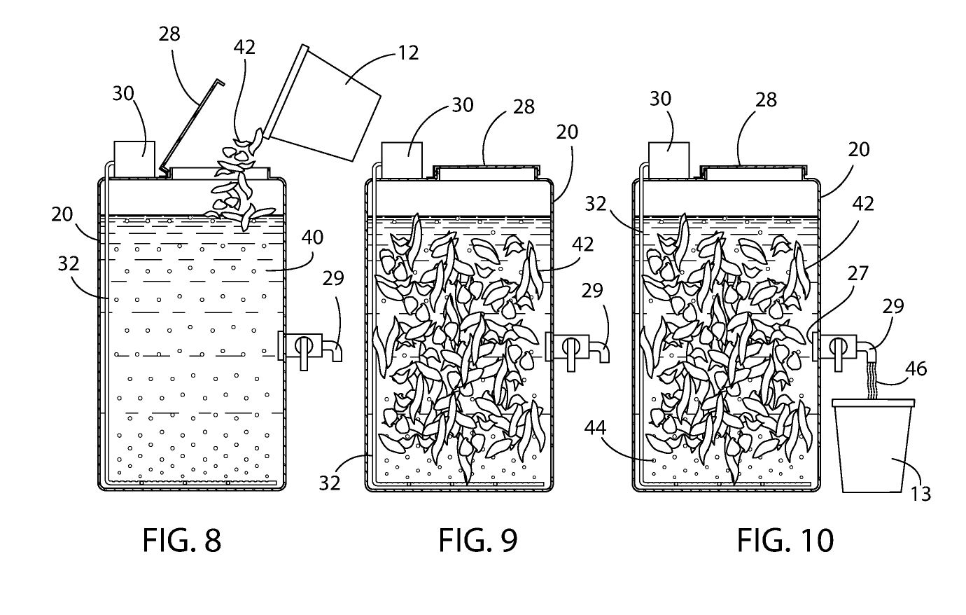

With the liquid 40 stored within the cavity 25 of the container 20, the organic materials 42 may be added. The organic materials 42 may comprise solids, liquids, or semi-solids. The organic materials 42 may be introduced into the liquid 40 through the first opening 26 of the container 20 as shown in FIG. 8. The cover 28 may be lifted to expose the first opening 26 so that the organic materials 42 may be poured or otherwise introduced through the first opening 26 into the cavity 25 to be mixed with the liquid 40.

FIG. 8 illustrates organic materials 42 being dispensed from an organic material container 12 into the cavity 25 through the first opening 26 of the container 20. It should be appreciated that the manner in which the organic materials 42 are introduced into the cavity 25 of the container 20 to mix with the liquid 40 may vary in different embodiments. For example, a conveyer could be utilized to transfer organic materials 42 into the container 20. Alternatively, a hose or other conduit could feed the organic materials 42 into the container 20 through the first opening 26.

With the organic materials 42 mixed within the liquid 40, the cover 28 to the container 20 may be closed to close off the first opening 26. This prevents contamination or interruption of the composting processes, such as by weather elements (rain, snow, or the like) or unauthorized access by animals such as vermin or rodents which may be drawn to the smells emanated from the container 20 during the composting process.

As the gas 44 is dispensed through the liquid 40 by the gas dispenser 34, the organic materials 42 will be continuously mixed with the liquid 40. Aerobic organisms will be supported by the aeration of the liquid 40 which will improve efficiency of the composting process. Organic materials 42 may be added at any time to the liquid 40 during the composting process. In some embodiments, the container 20 may include a heater (not shown) which heats the liquid 40 to aid in the composting process.

The composting process will produce compost 46 which may be dispensed through the second opening 27. The compost 46 may be retrieved from the container 20 while the aerobic composting system 10 is in operation producing additional compost 46. The composting process does not need to be stopped in order to dispense compost 46 so that there are no interruptions when dispensing compost 46, such as through the second opening 27.

The compost 46 may comprise a liquid, a solid, or a semi-solid. In either case, the compost 46 may be retrieved from the container 20 via the second opening 27. In the embodiment shown in the figures, the second opening 27 comprises a spigot 29 which may be selectively opened to dispense the compost 46; such as into a separate compost receiver 13. After a desired amount of compost 46 is retrieved, the spigot 29 may be closed off to allow the composting process to continue until additional compost 46 is desired to be retrieved.

Unless otherwise defined, all technical and scientific terms used herein have the same meaning as commonly understood by one of ordinary skill in the art to which this invention belongs. Although methods and materials similar to or equivalent to those described herein can be used in the practice or testing of the aerobic composting system, suitable methods and materials are described above.

All publications, patent applications, patents, and other references mentioned herein are incorporated by reference in their entirety to the extent allowed by applicable law and regulations. The aerobic composting system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. An aerobic composting system, comprising:
a container adapted to store a volume of a liquid, the container comprising an upper end, a lower end, and a cavity for storing the volume of the liquid, wherein the container comprises a floor within the cavity;
an inlet on the container, wherein the inlet is adapted to receive an organic material such that the organic material is mixed with the liquid;
an outlet on the container, wherein the outlet is adapted to dispense a compost produced by decomposition of the organic material within the liquid;
a gas dispenser positioned within the container, wherein the gas dispenser is adapted to dispense a gas through the liquid so as to continuously mix the liquid and the organic material to produce the compost; and
a pump for supplying the gas to the gas dispenser.

2. The aerobic composting system of claim 1, wherein the liquid is comprised of water and the gas is comprised of oxygen.

3. The aerobic composting system of claim 1, wherein the pump is positioned near the upper end of the container.

4. The aerobic composting system of claim 3, further comprising a transfer conduit connected between the pump and the gas dispenser.

5. The aerobic composting system of claim 1, wherein the gas dispenser comprises a central dispenser conduit and a plurality of dispenser arms extending outwardly from the central dispenser conduit to form a grid covering the floor of the container within the cavity.

6. The aerobic composting system of claim 1, wherein the gas dispenser comprises a flow conduit extending upwardly from the floor of the cavity within the container.

7. The aerobic composting system of claim 6, wherein the gas dispenser comprises a dispenser arm fluidly connected to the flow conduit, wherein the dispenser arm is adapted to rotate when the gas flows through the flow conduit and the dispenser arm.

8. The aerobic composting system of claim 1, wherein the inlet is comprised of a first opening and the outlet is comprised of a second opening.

9. The aerobic composting system of claim 8, wherein the inlet is on the upper end of the container.

10. The aerobic composting system of claim 9, wherein the outlet is comprised of a spigot.

11. An aerobic composting system, comprising:
a container adapted to store a volume of a liquid, the container comprising an upper end, a lower end, and a cavity for storing the volume of the liquid, wherein the container comprises a floor within the cavity;
an inlet on the container, wherein the first opening is adapted to receive an organic material such that the organic material is mixed with the liquid;
an outlet on the container, wherein the second opening is adapted to dispense a compost produced by decomposition of the organic material within the liquid;
a flow conduit extending upwardly from the floor within the cavity of the container;
a pump fluidly connected to the flow conduit for supplying a gas to the flow conduit; and
a dispenser arm fluidly connected to the flow conduit, wherein the dispenser arm is adapted to dispense the gas through the liquid so as to continuously mix the liquid and the organic material to produce the compost.

12. The aerobic composting system of claim 11, wherein the dispenser arm is adapted to rotate within the cavity when the pump is activated.

13. The aerobic composting system of claim 11, wherein the flow conduit comprises an inner tube and an outer tube.

14. The aerobic composting system of claim 13, wherein the inner tube is connected to the pump and the outer tube is connected to the dispenser arm.

15. The aerobic composting system of claim 14, wherein the outer tube and the dispenser arm are adapted to rotate about the inner tube when the pump is activated.

16. The aerobic composting system of claim 11, wherein a first end of the dispenser arm comprises a first dispenser outlet and wherein a second end of the second dispenser outlet comprises a second dispenser outlet.

17. The aerobic composting system of claim 16, wherein the first dispenser outlet includes a first fin and wherein the second dispenser outlet includes a second fin.

18. The aerobic composting system of claim 17, wherein the first fin is oriented in a first direction and wherein the second fin is oriented in a second direction such that the dispenser arm rotates within the cavity when the pump is activated.

19. The aerobic composting system of claim 11, wherein the organic material comprises a solid.

20. A method for producing compost, comprising the steps of:
storing a volume of a liquid within a container, the container comprising an upper end, a lower end, a cavity for storing the liquid, and a floor within the cavity;
introducing an organic material into the liquid through a first opening on the container;
covering the first opening on the container;
dispensing a gas through the liquid within the container with a gas dispenser, the gas dispenser comprising a flow conduit fluidly connected to a dispenser arm, wherein the dispenser arm is adapted to rotate within the cavity;
mixing the organic material within the liquid to produce the compost; and
dispensing the compost through a second opening on the container.
